(19) United States
(12) Patent Application Publication
(10) Pub. No.: US 2021/0346728 A1
(43) Pub. Date: Nov. 11, 2021

(54) Protective Facemask And Method Of Manufacture

(71) Applicant: Heartland Health Products, LLC, Fairfield, OH (US)

(72) Inventors: Albert M. FISCHER, Fairfield, OH (US); Nicholas PENDLETON, Trenton, OH (US); Douglas M. MELTON, Kings Mills, OH (US); Francis J. FISCHER, JR., Bloomington, IN (US); Anna Jean McCORMICK, West Chester, OH (US)

(73) Assignee: Heartland Health Products, LLC, Fairfield, OH (US)

(21) Appl. No.: 17/316,936

(22) Filed: May 11, 2021

Related U.S. Application Data
(60) Provisional application No. 63/023,007, filed on May 11, 2020.

(51) Int. Cl. A62B 7/10; A41D 13/11; A62B 18/08; A62B 23/02

(52) U.S. Cl. CPC A62B 7/10; A41D 13/1115; A62B 23/025; A62B 18/084; A41D 13/1161

(57) ABSTRACT

A protective facemask includes: a facemask panel sized to cover at least a user's nose and mouth including at least one layer of filter material, where the facemask panel is generally rectangular having a pair of side edges with a vertical height and including folded pleats in the filter material running along the width of the facemask panel; and an elasticized headband panel fixed to an extending between the side edges of the facemask panel, where the vertical height of the headband panel is substantially the same as the vertical height of the side edges of the facemask panel where the panels are fixed to each other

### CROSS REFERENCE TO RELATED APPLICATIONS

The current disclosure claims priority to U.S. provisional application Ser. No. 63/023,007, filed May 11, 2020, the entire disclosure of which is incorporated by reference herein.

### BACKGROUND

N95 and other disposable respirators are the Personal Protective Equipment (PPE) most often used to control exposures to infections and many other environmental pollutants and allergens transmitted via the airborne route. However, they are the least effective in the “Hierarchy of Controls” with their effectiveness being highly dependent upon proper fit and use. While many such PPE may be referred to as either or both “masks” or “respirators”, the current disclosure may use the term “mask,” “facemask” and/or “respirator” interchangeably to include all such types of PPE equipment.

Prior art masks have similar designs that fall within two basic styles, 1) a flat mask with elastic straps or bands as shown in FIGS. 9 and 2) a formed mask with elastic straps or bands as shown in FIG. 10. While both have advantages and disadvantages, they both are fit and use dependent. The flat masks/respirators of FIG. 9 although flexible, leave gaps 100 at the mask-to-face interface and require masks/respirators to be secured high and low on the head to maintain an effective position, typically via thin elastic straps or bands.

The fitting masks/respirators of FIG. 10 better address the fit issue but present use issues by securing the masks/respirators via elastic straps or bands 120 that are placed above/over the ears and is a more rigid fit making it hard to follow the contours of the many different face and chin shapes. Additionally, multiple sizes are needed to fit a specific face and chin shape.

Both prior art mask styles of FIGS. 9 and 10 require a secondary operation to manufacture.

### SUMMARY

Embodiments of the disclosure provide a modification to the current flat and rigid style of protective masks/respirators that reduces the mask-to-face interface issues of proper fit and use. Additionally, the embodiments of the present disclosure eliminate the need for a secondary operation to manufacture. An exemplary mask according to the current disclosure creates a unique comfortable fit by utilizing a mask with multiple folds that run side-to-side across and stretched around the face. The multiple folds positioned in the filter material layer create pockets for the nose, mouth and chin to fit into comfortably. Embodiments of the current disclosure improve the fit of both the flat and rigid style masks/respirators by using a wide, elasticized headband with multiple elastic bands secured to the fabric materials with glue to resist the band from moving out of position. The wide headband is sealed to the mask along the entire mask vertical height. Each individual elastic band secured within the headband stretches to follow the contour of any shape head while pulling the facemask against the sides of the face thereby eliminating the gaps created by the current mask styles.

A first aspect of the current disclosure is to provide a protective facemask that includes: a facemask panel sized to cover at least a user's nose and mouth including at least one layer of filter material, where the facemask panel is generally rectangular having a pair of side edges with a vertical height and including folded pleats in the filter material running along the width of the facemask panel; and an elasticized headband panel fixed to an extending between the side edges of the facemask panel, where the vertical height of the headband panel is substantially the same as the vertical height of the side edges of the facemask panel where the panels are fixed to each other. In a more detailed embodiment, the facemask panel includes a bottom elastic band running approximate the bottom of the facemask panel along the width of the facemask panel for the purpose of reducing gaps between the facemask panel and a chin area of the user. In a further detailed embodiment, the facemask panel includes a top elastic band running approximate the top of the facemask panel along the width of the facemask panel. In a further detailed embodiment, the facemask panel includes a band of deformable material running approximate the top of the facemask panel along a majority of the width of the facemask panel.

Alternatively, or in addition, the facemask panel includes an outer layer of hydrophobic material, middle layer of filter material and an inner layer of hydrophilic material. Alternatively, or in addition, the headband panel includes an outer layer of nonwoven material, an inner layer of nonwoven material and a plurality of elastic bands running the width of the headband panel bonded between the inner and outer layers of nonwoven material. Alternatively, or in addition, the protective facemask includes a face-shield connected thereto or incorporated therein. Alternatively, or in addition, the facemask further includes a flow-wrapper packaging the protective facemask therein, where product information and/or branding may be printed on the flow-wrapper. Alternatively, or in addition, the facemask panel also includes a nose wire attached to the upper edge of the facemask panel for manual deformation to grip on a user's nose. Alternatively, or in addition, the elasticized headband panel includes a split running along its width allowing the elasticized headband panel to be separated into two vertically separated headband portions. Alternatively, or in addition, the facemask panel and elasticized headband panel are formed as part of a continuous hoop of materials that are cut to produce individual facemasks.

In a second aspect, a protective facemask includes: a facemask panel sized to cover at least a user's nose and mouth including at least one layer of filter material, where the facemask panel is generally rectangular having a pair of side edges with a vertical height and including folded pleats in the filter material running along the width of the facemask panel; a pair of elasticized headband panels respectively fixed to an extending from respective side edges of the facemask panel, where the vertical height of each of the headband panels is substantially the same as the vertical height of the side edges of the facemask panel where the panels are fixed to each other; and (a) ear loops incorporated into or coupled to each headband panel, and/or (b) a coupling for removably connecting the headband panels behind the wearer's head in use. In a further detailed embodiment, the facemask panel includes an elastic band running approximate the bottom of the facemask panel along the width of the facemask panel for the purpose of reducing gaps between the facemask panel and a chin area of the user. Alternatively, or in addition, the facemask panel includes an outer layer of hydrophobic material, middle layer of filter material and an inner layer of hydrophilic material. Alternatively, or in addition, the headband panels include an outer layer of nonwoven material, an inner layer of nonwoven material and a plurality of elastic bands running the width of the headband panel bonded between the inner and outer layers of nonwoven material. Alternatively, or in addition, the facemask panel also includes a band of deformable material attached to the upper edge of the facemask panel for manual deformation to grip on a user's nose. The band of deformable material may extend a majority of the width of the facemask panel in embodiments.

In another aspect, a method for manufacturing a protective facemask includes steps of: (a) forming a continuous hoop of materials including a first hemispherical facemask portion of the continuous hoop and a second hemispherical headband portion of the continuous hoop, where the facemask portion includes an outer layer of hydrophobic material, middle layer of filter material and an inner layer of hydrophilic material and including folded pleats at least in the filter material layer, the folded pleats running in a direction perpendicular to an axis of the continuous hoop, and where the headband portion includes an outer layer of nonwoven material, an inner layer of nonwoven material and a plurality of elastic bands running perpendicular to an axis of the continuous hoop bonded between the inner and outer layers of nonwoven material; and (b) repeatedly cutting the continuous hoop along a running axis of the continuous hoop to form a plurality of individual face masks.

In a more detailed embodiment, the forming step (a) includes steps of: forming a first continuous web of the facemask portion; forming a second continuous web of the headband portion; stacking the first and second continuous webs; and bonding elongated edges of the first and second continuous webs to form the continuous hoop. In a further detailed embodiment, the step of forming the first continuous web includes steps of: providing an elastic band running along each elongated edge of the first continuous web; and providing a plurality of deformable bands along one elongated edge of the first continuous web. In a further detailed embodiment, the deformable bands are separated by a distance less than a length of each deformable band.

These and other aspects and advantages of the current disclosure will be apparent from the following detailed description, the appended claims and the attached drawings.

### BRIEF DESCRIPTION OF THE DRAWINGS

FIG. 1A provides a planar view of a facemask panel portion and a machine direction of its assembly according to an exemplary embodiment (provided dimensions are exemplary);

FIG. 1B provides a planar view of a headband panel portion and a machine direction of its assembly according to an exemplary embodiment (provided dimensions are exemplary);

FIG. 2 provides a schematic representation of the facemask panel portion (prior to folding) showing the layers of components and relative positions of the layer components (provided dimensions are exemplary);

FIG. 3 provides a schematic representation of the facemask panel portion after folding (provided dimensions are exemplary);

FIG. 4 provides a schematic representation of the headband panel portion showing the layers of components and the relative positions of the layer components (provided dimensions are exemplary);

FIG. 5 is a view of an exemplary facemask/respirator of the current disclosure as worn by an individual;

FIG. 6 is an end view (top or bottom view) of an exemplary facemask of the current disclosure;

FIG. 7 is an axial view (rear view) of an exemplary facemask of the current disclosure;

FIG. 8 is a perspective view of another exemplary facemask/respirator according to the current disclosure;

FIG. 9 is a prior art facemask/respirator as worn by an individual; and

FIG. 10 is a prior art facemask/respirator as worn by an individual.

### DETAILED DESCRIPTION

Present disclosure provides a modification to the current flat and rigid style of masks/respirators that reduces the mask-to-face interface issues of proper fit and use. Additionally, the present disclosure eliminates the need for a secondary operation to manufacture.

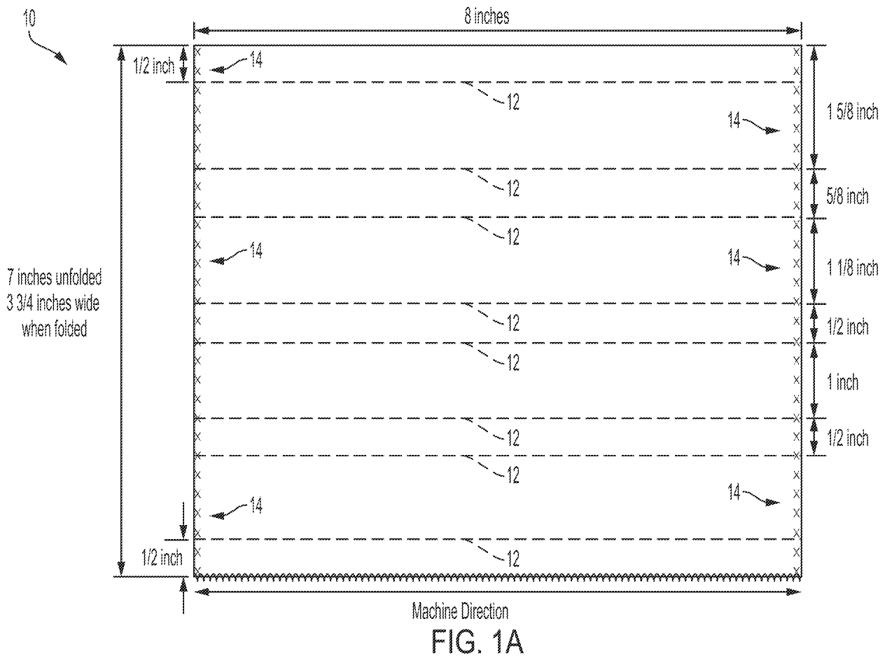

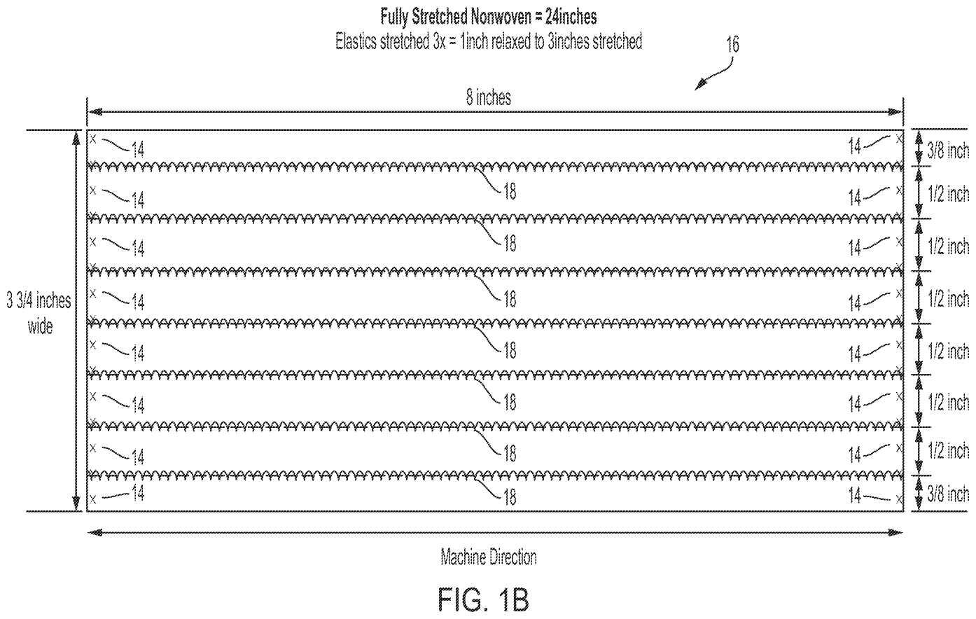

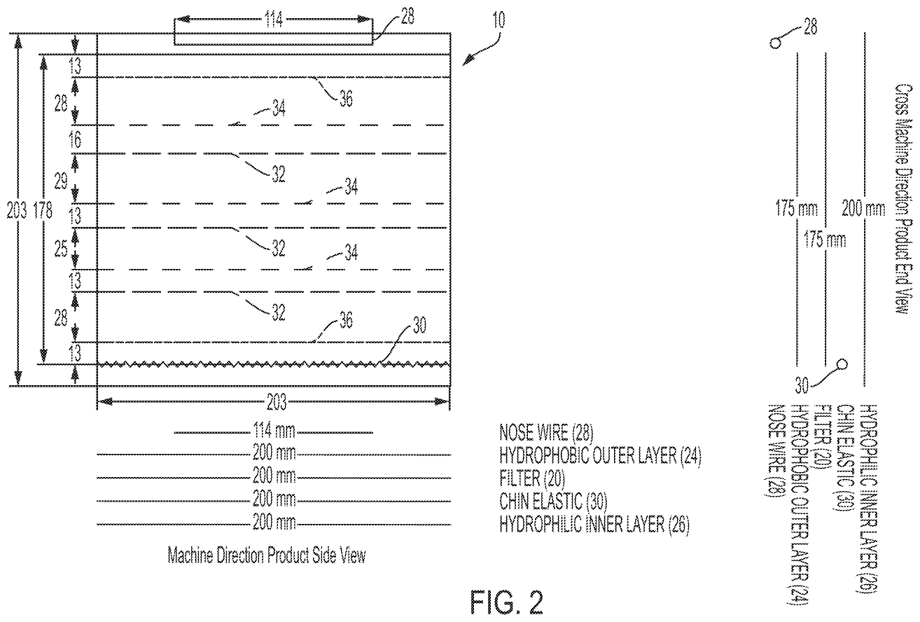

The exemplary mask according to the current disclosure creates a unique comfortable fit by utilizing a mask with multiple folds that run side-to-side across and stretched around the face. FIG. 1A provides a facemask panel 10 for an exemplary mask. The multiple folds 12 positioned in the filter material layer 20 (see FIG. 2) create pockets for the nose, mouth and chin to fit into comfortably. The bond pattern 14 is for bonding the facemask panel 10 to the headband web 16 (see FIG. 1B)

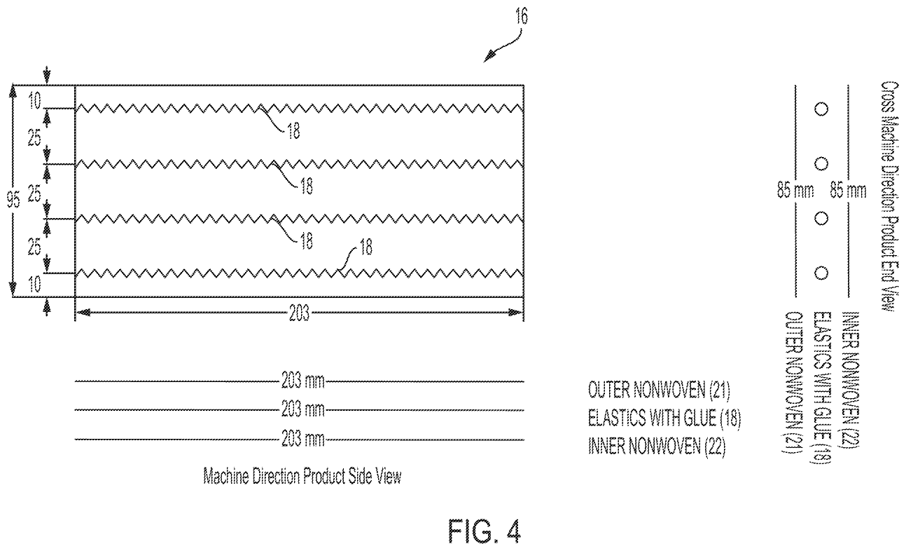

Referring to FIG. 1B, the current disclosure improves the fit of both the flat and rigid style masks/respirators by using a wide, elasticized headband 16 with multiple elastic bandsl8 secured to the fabric materials 21, 22 (See also FIG. 4) with glue to prevent the band from moving out of position. The wide headband is sealed to the facemask panel 10 along the entire mask vertical height using bond pattern 14. Each individual elastic band 18 secured within the headband 16 stretches to follow the contour of any shape head while pulling the facemask panel 10 against the sides of the face thereby eliminating the gaps created by the current mask styles. Additionally, the wide, elasticized headband 16 pulls and contours around and under the chin to prevent gaps between the user and the mask. For example, normal operating room protocol has the mask-wearer face forward toward the patient if the mask-wearer needs to sneeze. With prior art masks/respirators, forward facing towards the patient helps to avoid side spray of droplets toward the patient through the gaps between the prior art masks/respirators and the wearer's face. The current disclosed mask design would minimize this risk by having he sides close fitting and fewer side gaps.

FIG. 2 illustrates construction of an exemplary face mask panel 10 (dimensions in millimeters). The exemplary face mask panel 10 includes hydrophobic outer layer material 24, a middle layer filter material 20 and a hydrophilic inner layer material 26. FIG. 2 also illustrates inward fold lines 32, outward fold lines 34 and inside non-woven fold-over lines 36. The face mask panel may also include a nose wire 28 attached to the upper edge of the panel for manual deformation to grip on a user's nose.

And the face mask panel may also include a band of chin elastic 30 positioned between the middle filter material layer 20 and the hydrophilic inner layer material 26, where the chin elastic band 30 runs the width of the panel 10 near the bottom of the panel to better grip and conform to a user's chin area when in use.

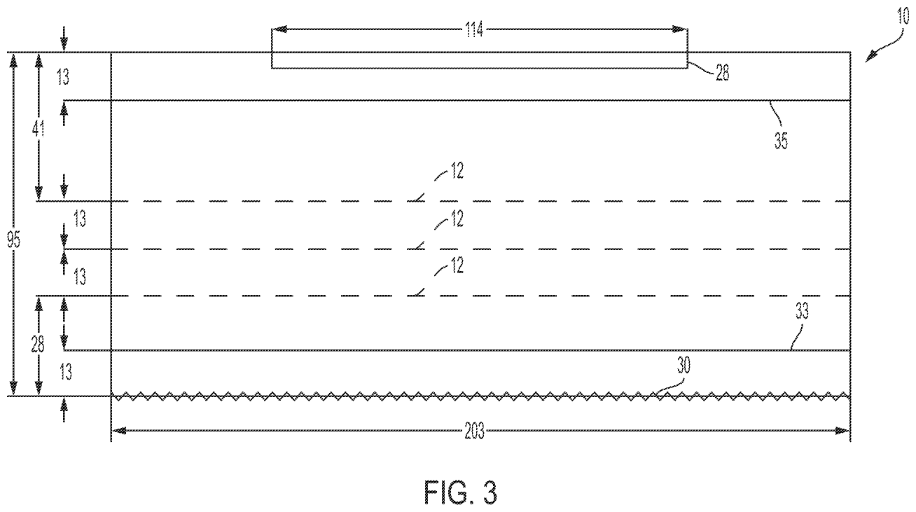

FIG. 3 illustrates the exemplary face mask panel 10 as folded/pleated prior to construction of the face mask (dimensions in millimeters).

FIG. 4 illustrates construction of an exemplary elasticized head band panel 16 (exemplary dimensions in millimeters). The exemplary head band panel 16 includes an outer nonwoven material layer 21 and an inner nonwoven material layer 22 that sandwich a plurality of elastic bands 18 bonded therebetween and running the width of the head band panel 16.

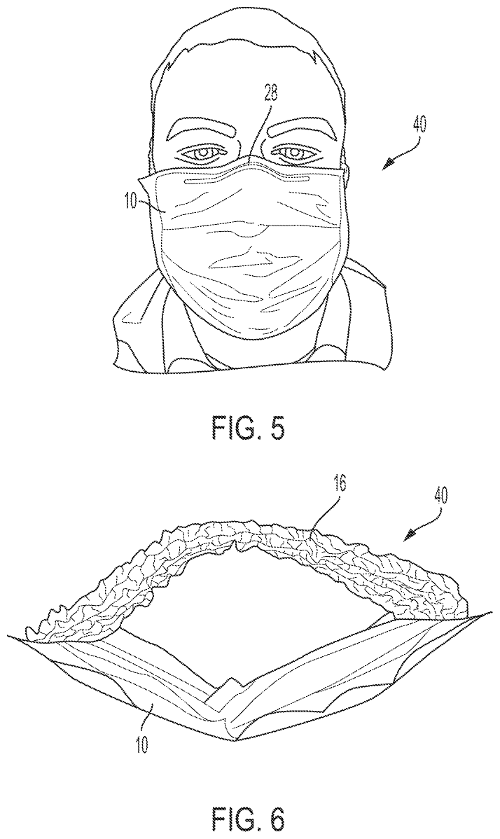

The assembled Mask/Respirator Assembly 40 (see FIGS. 5-7) is made via converting lycra, a nose wire 28 (discreet or full length), adhesive, and non-woven raw materials (may include spunbond polypropylene, both hydrophobic and hydrophilic; melt-blown polypropylene; and cotton). The mask assembly 40 is made in different sizes to accomodate a variety of head/face sizes and varying facial profiles and sizes.

The face mask portion 10 of the assembly 40 may be made via unwinding several non-woven materials and combining via methods including adhesive bonding, heat and pressure bonding, or ultra-sonic bonding. As part of the making process, multiple folds 14 are made on all or some of the layers to combine the layers of the mask and to provide pleats that will open in use. A bottom fold-over 33 in the nonwoven layer 26 captures the elastic or extensible material 30 and when the folder over 33 is bonded to the nonwoven layer 24, the bond keeps the layers from separating. A nose wire 28 (which may be discrete, full-length or majority length) may be retained in a similar fold-over 35 in the top portion of the face mask portion 10.

The headband portion 16 of the assembly 40 may be made via unwinding several non-woven materials 21, 22 and several elastic strands 18. The strands 18 are sandwiched between the non-wovens 21, 22 and adhered at a constant strain. This results in a headband that can stretch to 2 for 4 times its relaxed length. Elastics with different properties can be used in differing portions of the headband and extended at different elongations to give different stretch/fit properties. The mask 10 and the headband 16 are combined together to form a continuous Mask Assembly hoop via a heat and pressure bonding or ultra-sonic bonding process (for example, along bonding patterns 14). Multiple masks/respirators 40 are machine formed in a continuous, circular/hoop-shaped web, where the continuous web is cut into individual masks/respirators 40 and packaged. When combining a multilayer product, there are the same number of unwind stands as there are materials being laminated through the manufacturing line. To make the mask, each substrate is unwound simultaneously and pulled through the converting operation. The pull is primarily developed by the rewinder running at a predetermined speed typically faster than the unwind stand. This keeps the material in tension resulting in a product with little-to-no wrinkles ensuring that the laminating process delivers a product that meets the quality standards. So, the three, or could be more, substrates are transformed into a single, multilayer product that is ultrasonically welded, glued, heat sealed or mechanically welded together.

Another exemplary method for constructing an exemplary facemask according to the current disclosure is also provided according to the following steps (and sub-steps). It will be apparent that not all the following steps need to be performed in any specific order (although some steps necessarily follow others). It will also be apparent that the dimensions are only example dimensions and alternate dimensions can be used as desired. Further, it will be apparent that not every step is necessary to practice certain embodiments.
1. Cut mask 10 materials to size
   a. Outer nonwoven 24 cut to 7″×8″
   b. Inner barrier layer 20 cut to 7″×8″
   c. Inner nonwoven 26 cut to 8.75″×8″
   d. Metal wire 28 cut to 4.5″
2. Cut head band 16 materials to size
   a. Both nonwovens 21, 22 cut to 3.75″×24″
3. Assemble head band 16
   a. Fasten one of the nonwoven layers 21, 22 to a surface to attach stretch material 18 to avoid the nonwoven from moving while the stretch material is being applied
   b. Apply adhesive to the stretch material 18 and then apply the stretch material to the nonwoven 21, 22
   c. Apply the second nonwoven to the stretch material 21, 22 applied in step 3b using adhesive on the stretch material 18
   d. The head band 16 is now finished being assembled and can be removed from being fastened to the making surface
4. Assemble the mask filtration materials
   a. Fasten the Inner nonwoven 26 to a surface
   b. Lay the Inner barrier layer 20 centered on the Inner nonwoven in the 8″ length with the extra material of the Inner nonwoven having an equal amount extended past the Inner barrier material.
   c. Lay the Outer nonwoven 24 directly onto the Inner barrier layer in the same fashion as described in step 4b.
   d. Apply adhesive on the extended extra Inner nonwoven material 26 for both extended pieces of material.
   e. On one side of the extra Inner nonwoven 26 apply the metal wire 28 centered in the length direction and fold over the extra Inner nonwoven material trapping the wire and adhering the material to the Outer nonwoven.
   f. On the other side of the extra Inner nonwoven 26, extend a piece of stretch material 30 past the length of the materials and fold over the material similarly to step 4e trapping the stretch material 30 in the folded over Inner nonwoven 26. Both folds of the Inner nonwoven 26 should be folded over and attached to the Outer nonwoven 24 material at this point.
   g. Create 3 pleats/folds 12 in the length direction to reduce the width of the web to make it narrower; this web should now be the same width as the assembled head band web.
5. Assemble the two webs to make a Mask
   a. With the folded mask filtration web laying on top of the head band web, both oriented in the same length direction, bond both edges together across the width of the webs.

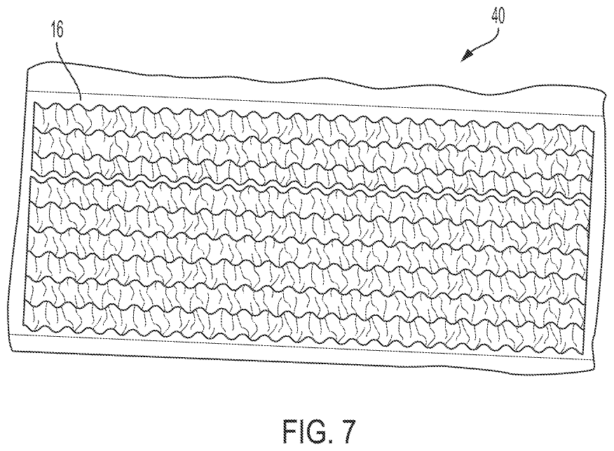

FIG. 5 is an image of an exemplary face mask 40 according to the current disclosure being worn by a user. FIG. 6 is top view of an exemplary face mask 40 according to the current disclosure. FIG. 7 is a back view (showing the headband panel 16) of the exemplary face mask 40 according to the current disclosure.

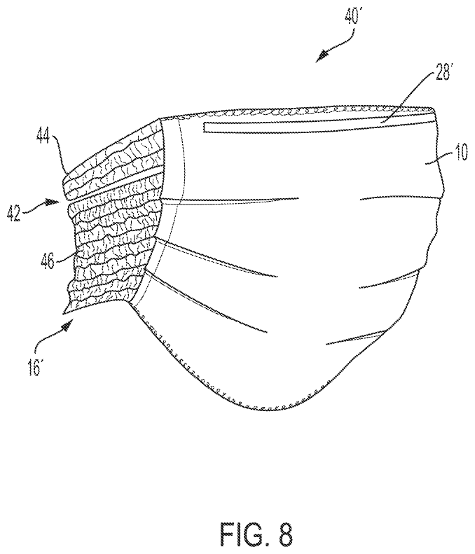

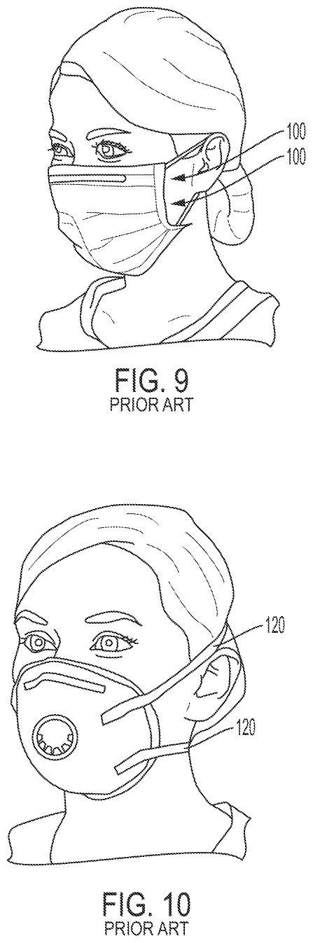

FIG. 8 is an exemplary embodiment of the assembly 40′ where the headband panel 16′ has a horizontally extending cut 42 to cut away upper 44 and lower 46 sections of the headband panel 16′, thus giving the functionality of having multiple headbands on the same mask unit. FIG. 8 also provides an example of the facemask wire 28′ extending the majority of the width of the facemask panel 10.

Having described various inventions according to the above description and the attached drawings, it will be apparent that modifications can be made without departing from the general scope of such inventions as claimed. For example, the elasticized headband may not necessarily be a continuous panel extending between the side edges of the facemask panel—the headband, for example, may include two panels respectively extending from each of the side edges of the facemask panel. In such an alternate embodiment, each of the two headband panels may each include an ear-loop connected thereto or incorporated therein. Alternatively, the two headband panels may each include a coupling mechanism allowing the two headband panels to be removably connected to each other behind the wearer's head (e.g., laces for tying, button/loop, snaps, buckles/straps, hooks/rings, Velcro, and the like). It is also within the current disclosure that certain embodiments may include or be connected to a face-shield. It is also to be understood that the dimensions provided with respect to exemplary embodiments are provided for example purposes and those of ordinary skill will be able to modify the dimensions as desired while still falling within the scope of the inventions as claimed.

Furthermore, it may be within the scope of the disclosure to have a flow wrapper to individually wrap every mask. Such a flow wrapper may be used as a way to brand and market the product. It may also be beneficial in some embodiments to print information directly onto components of the mask. The flow wrap may be used to protect the mask and to contain printed information such as communicating instructions, certifications, or to Brand.

What is claimed is:

1. A protective facemask comprising:
a facemask panel sized to cover at least a user's nose and mouth including at least one layer of filter material, the facemask panel being generally rectangular having a pair of side edges with a vertical height and including folded pleats in the filter material running along the width of the facemask panel; and
an elasticized headband panel fixed to an extending between the side edges of the facemask panel, the vertical height of the headband panel being substantially the same as the vertical height of the side edges of the facemask panel where the panels are fixed to each other.

2. The protective facemask of claim 1, wherein the facemask panel includes a bottom elastic band running approximate the bottom of the facemask panel along the width of the facemask panel for the purpose of reducing gaps between the facemask panel and a chin area of the user.

3. The protective facemask of claim 2, wherein the facemask panel includes a top elastic band running approximate the top of the facemask panel along the width of the facemask panel.

4. The protective facemask of claim 3, wherein the facemask panel includes a band of deformable material running approximate the top of the facemask panel along a majority of the width of the facemask panel.

5. The protective facemask of claim 1, wherein the facemask panel includes an outer layer of hydrophobic material, middle layer of filter material and an inner layer of hydrophilic material.

6. The protective facemask of claim 1, wherein the headband panel includes an outer layer of nonwoven material, an inner layer of nonwoven material and a plurality of elastic bands running the width of the headband panel bonded between the inner and outer layers of nonwoven material.

7. The protective facemask of claim 1, wherein the protective facemask includes a face-shield connected thereto or incorporated therein.

8. The protective facemask of claim 1, further comprising a flow-wrapper packaging the protective facemask therein.

9. The protective facemask of claim 8, further comprising product information and/or branding printed on the flow-wrapper.

10. The protective facemask of claim 1, wherein the facemask panel also includes a nose wire attached to the upper edge of the facemask panel for manual deformation to grip on a user's nose.

11. The protective facemask of claim 1, wherein the elasticized headband panel includes a split running along it's width allowing the elasticized headband panel to be separated into two vertically separated headband portions.

12. The protective facemask of claim 1, wherein the facemask panel and elasticized headband panel are formed as part of a continuous hoop of materials that are cut to produce individual facemasks.

13. A protective facemask comprising:
a facemask panel sized to cover at least a user's nose and mouth including at least one layer of filter material, the facemask panel being generally rectangular having a pair of side edges with a vertical height and including folded pleats in the filter material running along the width of the facemask panel;
a pair of elasticized headband panels respectively fixed to an extending from respective side edges of the facemask panel, the vertical height of each of the headband panels being substantially the same as the vertical height of the side edges of the facemask panel where the panels are fixed to each other; and at least one of
(a) ear loops incorporated into or coupled to each headband panel, or
(b) a coupling for removably connecting the headband panels behind the wearer's head in use.

14. The protective facemask of claim 13, wherein the facemask panel includes an elastic band running approximate the bottom of the facemask panel along the width of the facemask panel for the purpose of reducing gaps between the facemask panel and a chin area of the user.

15. The protective facemask of claim 13, wherein the facemask panel includes an outer layer of hydrophobic material, middle layer of filter material and an inner layer of hydrophilic material.

16. The protective facemask of claim 13, wherein the headband panels include an outer layer of nonwoven material, an inner layer of nonwoven material and a plurality of elastic bands running the width of the headband panel bonded between the inner and outer layers of nonwoven material.

17. The protective facemask of claim 13, wherein the facemask panel also includes a band of deformable material attached to the upper edge of the facemask panel for manual deformation to grip on a user's nose.

18. The protective facemask of claim 17, wherein the band of deformable material extends a majority of the width of the facemask panel.

19. A method for manufacturing a protective facemask, comprising steps of:
forming a continuous hoop of materials including a first hemispherical facemask portion of the continuous hoop and a second hemispherical headband portion of the continuous hoop,
the facemask portion including an outer layer of hydrophobic material, middle layer of filter material and an inner layer of hydrophilic material and including folded pleats at least in the filter material layer, the folded pleats running in a direction perpendicular to an axis of the continuous hoop, and
the headband portion including an outer layer of nonwoven material, an inner layer of nonwoven material and a plurality of elastic bands running perpendicular to an axis of the continuous hoop bonded between the inner and outer layers of nonwoven material; and
repeatedly cutting the continuous hoop along a running axis of the continuous hoop to form a plurality of individual face masks.

20. The method of claim 19, wherein the forming step includes steps of:
forming a first continuous web of the facemask portion;
forming a second continuous web of the headband portion;
stacking the first and second continuous webs; and
bonding elongated edges of the first and second continuous webs to form the continuous hoop.

21. The method of claim 20, wherein the step of forming the first continuous web includes steps of:
providing an elastic band running along each elongated edge of the first continuous web; and
providing a plurality of deformable bands along one elongated edge of the first continuous web.

22. The method of claim 21, wherein the deformable bands are separated by a distance less than a length of each deformable band.
